(19) United States
(12) Patent Application Publication
(10) Pub. No.: US 2004/0088353 A1
(43) Pub. Date: May 6, 2004

(54) User interface

(76) Inventors: Stuart Mendelsohn, Stockholm (SE); Niels Morch, Frederiksberg (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/433,673

(22) PCT Filed: Dec. 5, 2001
(86) PCT No.: PCT/IB01/02768

(30) Foreign Application Priority Data
Dec. 5, 2000 (GB) 0029622.8

(51) Int. Cl. G06F 15/16

(52) U.S. Cl. 709/203; 709/223

(57) ABSTRACT

A system providing at least one management service, wherein the service can be accessed by a user using one of a plurality of user-interfaces, wherein a service management function provides a generic definition of the service, and a user-interface modality independent user interaction layer provides an interaction layer between the service management function and the user-interface used by the user.

### FIELD OF THE INVENTION

The present invention relates to a technique for improving the exchange of information between a system and a user, and particularly the exchange of information between one of a plurality of different types of user interfaces and a shared service.

### BACKGROUND TO THE INVENTION

User management of a set of domain specific entities involves the manipulation of associated entity attributes via a user-interface. The entity to be managed may be hierarchically comprised of other domain entities. For example, in the domain of intelligent network (IN) service management, a pre-paid service is an example of a domain entity requiring management by users.

FIG. 1 illustrates a simple example of a service entity, specifically a pre-paid service entity 100 provided on a domain entity server 130. The pre-paid service entity 100 is comprised of a subscriber entity 102, a subscription account entity 104 and an allowed recharge methods entity 106. The subscription account entity 104 in turn contains a balance attribute 112, and the allowed recharge methods entity 106 contains a list of available recharge methods 114 (e.g. by voucher, and by credit card). Further, the pre-paid service entity 100 itself contains a service enabled attribute 108. The pre-paid service entities reside on, and are accessible via, the domain entity server 130.

Certain users are allowed to manage aspects of the pre-paid service entity 100, including the subscriber identified by the attributes of the subscriber entity, and the operator providing the pre-paid service.

The entities provided in the domain entity server 130 may be considered to comprise the content plane of the server. The domain entity may also comprise a constraint plane, for imposing constraints on management by limiting the set of allowed attribute manipulations. Such constraints may be static or depend on the value of other entity attributes. In the IN pre-paid service example of FIG. 1, a balance domain constraint 118 is provided, for example, such that the subscriber is not allowed to add to the balance attribute of the account entity (i.e. recharge the account) if the list of allowed recharge methods (in the allowed recharge method entity 106) is empty.

The domain entity server may further include a plurality of further service entities, as generally represented by reference numerals 116a to 116c. Similarly the domain entity server may be provided with a plurality of further domain constraints, as represented by reference numerals 120a to 120c.

User management is facilitated by a user-interface. The user-interface is characterized by its ability to present output information to the user, and to accept input information from the user. Output may be presented using one or more of a set of output mediators capable of presenting, for example, textual and graphical information (such as HTML and WML), or verbal information (using text-to-voice technology). Similarly, input may be accepted using one or more of a set of input mediators capable of recognizing, for example, textual and graphical input (such as HTML and WML forms), dual tone multiple frequency (DTMF) input (using Interactive Voice Response (IVR) technology), or verbal input (using speech recognition technology). An output mediator and an input mediator together form a user-interface type or modality.

The interaction between user and system during management of domain entities is governed by a conversational finite state machine, or interaction dialog. The interaction dialog defines a set of states, characterized by a sequence of information exchanges (output and/or input). Depending on attributes, typically provided via the input mediator, transitions between conversational states occur.

An example interaction dialog for the pre-paid example of FIG. 1 is illustrated in FIG. 2. As shown in FIG. 2 one conversational state, such as the recharge menu state 202, may query the user to select a recharge method. From there, a transition to a voucher recharge state 204 handling voucher recharging occurs for one user selection as illustrated by arrow 216, whilst a transition to a credit card recharge state 206 handling credit card recharge occurs for another user selection as illustrated by arrow 218.

Other conversational states are generally illustrated by reference numerals 208 to 214. Arrows also illustrate various other transitions between states.

Constraints on management imposed by the domain are reflected in constraints on the set of possible transitions between conversational states in the interaction dialog. For example, the transition to the conversational state that queries the user to select a recharge method is disabled if the list of allowed recharge methods is empty, as indicated by a dashed arrow 220 in FIG. 2.

Additionally shown in FIG. 2 are further interaction dialogs of the interaction dialog server 230, represented by reference numerals 222a to 222c.

In addition to domain-imposed constraints on management, the manifestation of an interaction dialog under a particular user-interface modality may impose further constraints. In the IN pre-paid service example, the user is free to choose the order in which to input the credit card number and the expire date in the conversational state handling credit card recharge if the user-interface modality is a combination of HTML output and HTML form input (so-called WEB modality). If, however, the user-interface modality is a combination of verbal output and DTMF input (so-called IVR modality), the user will be prompted for the two pieces of input sequentially. In other words, the HTML output mediator facilitates simultaneous presentation of several pieces of information, while the verbal output mediator does not, thus imposing a constraint specific to the IVR modality.

Today, management systems implicitly represent interaction dialogs in the implementation of each user-interface modality. A WEB interface implementation of the IN pre-paid service example given above would implicitly contain the total set of constraints imposed on the interaction dialog by the domain and the use of the WEB modality in combination. Similarly, an IVR interface implementation would implicitly contain the total set of constraints imposed by the domain and the IVR modality in combination.

Thus currently the interaction dialog underlying a user-interface is dependent on the user-interface modality. The user does not necessarily experience the same sequence of information exchanges and state transitions if the interaction with the system is with a WEB or a WAP user-interface for example. This leads to a problem in so far as different user-interfaces may provide for a user to input a value or response that is not supported by a service implemented on that user-interface. In summary, if there are several types of user-interfaces available, it is currently necessary to determine separately for each kind of interface the way in which the interactions should be handled.

It is therefore an aim of the present invention to provide an improved technique for combining a user-interface with an interaction dialog, which results in improved operation of the user-interface.

### SUMMARY OF THE INVENTION

In one aspect the present invention provides a user interaction layer providing an interface between a plurality of user-interfaces and a service management function, wherein the user interaction layer is a generic layer being user-interface modality independent. The service management function provides the interaction layer with access to both domain entities from the domain entity server and interaction dialogs from the interaction dialog server.

The user interaction layer may receive a generic definition of an interaction dialog from the service management function. The interaction dialog is provided to the interaction layer independently of user-interface modality. The interaction dialog may be provided in extensible mark-up language. The interaction dialog may be provided to manage domain specific entities, e.g. belonging to the domain of intelligent network.

There may be provided a plurality of means, respectively associated with the plurality of user-interfaces, for defining specific user-interfaces from the generic interaction dialog. The means may be adapted to apply rules and constraints associated with the specific user-interface.

A user-interface may be one of a WEB interface, a WAP interface, an SMS interface, an IVR interface, a voice interface, or an e-mail interface.

In a further aspect the present invention provides a method of providing an interface between a plurality of user interfaces and a service management function comprising providing a generic interface layer being user-interface modality independent. The method may further comprise providing the interface layer with a generic definition of service management attributes, in terms of domain entities provided by the domain entity server. The generic definition of the service management attributes is preferably provided by the service management function.

The method may further comprise defining, in the interface layer, a plurality of specific user-interfaces from the generic interaction dialog definition, each corresponding to one of the plurality of user-interface types.

The specific user-interfaces may be defined in dependence on rules and constraints associated with the specific user-interface type. A management service may be enabled in accordance with said rules and constraints. In a further aspect the present invention provides a system providing at least one management service, wherein the management service can be accessed by a user using one of a plurality of user-interfaces, wherein a service management function provides a generic definitions of both the management service attributes and the interaction dialog, and a user-interface modality independent user interaction layer provides an interface between the service management function and the one user-interface used by the user.

The interaction layer may comprise means for deriving a plurality of definitions of specific user-interfaces from the generic definitions of the management service attributes and interaction dialog, each corresponding to one of the plurality of user interface types.

The service management function and the interaction layer may be provided by a central service provider. Each user-interface may be provided on a user device.

In a still further aspect of the present invention there is provided an interaction dialog for defining the interaction of a user-interface, the interaction dialog being provided by a service management function for controlling a user interaction layer, wherein the user interaction layer provides an interface between a plurality of user-interfaces and the service management function, the interaction dialog being provided in a form independent of the user-interface modality.

The interaction dialog may represent service logic behaviour. The interaction dialog may be provided in extensible mark-up language. The service management function may represent an intelligent network element. The service management function may control the user interaction layer in extensible mark-up language.

In another aspect the present invention provides a method of defining the interaction of a user-interface comprising providing an interaction dialog from a service management function for controlling a user interaction layer, the user interaction layer providing an interface between a plurality of user interfaces and a service management function, the interaction dialog being provided in a form independent of the user-interface modality.

The user interaction dialog may provide a generic definition of a service. There may be defined a plurality of means, respectively associated with the plurality of user interfaces, for defining specific user interfaces based on the interaction dialog. The means may apply rules and constraints associated with a specific user interface.

The interaction dialog may be defined in extensible mark-up language.

The invention thus provides a generic technique for representing an interaction dialog independent of user-interface modality. The invention provides a generic technique for representing rules and constraint specific to a given user-interface type. The invention further provides a generic technique for defining the user-interface for the user interaction represented by a generic interaction dialog for a plurality of user-interface types.

The invention advantageously provides explicit (as opposed to implicit) representation of data for service management interfaces. Explicit rules make the management interface easier to use. Management interfaces can be created in a faster time, and automatic interface creation is now possible. The previous manual requirement for implementation specifications can result in the omission of required functionality and introduce errors, and these problems are now avoided. The generic interface specification allows different user-interface types to share the same behaviour, and new interface types can be supported quickly.

### BRIEF DESCRIPTION OF THE FIGURES

The invention will be best understood by way of example with reference to the accompanying drawings in which:

FIG. 1 illustrates a domain entity for the example of a pre-paid service;

FIG. 2 illustrates an interaction dialog for the example of the pre-paid service;

FIG. 3 illustrates in block form the principle of the present invention;

FIG. 4 illustrates the main functional elements of one of the blocks of FIG. 3 in accordance with the present invention; and

FIG. 5 illustrates an example implementation of the present invention in a WEB interface environment.

### DESCRIPTION OF PREFERRED EMBODIMENTS

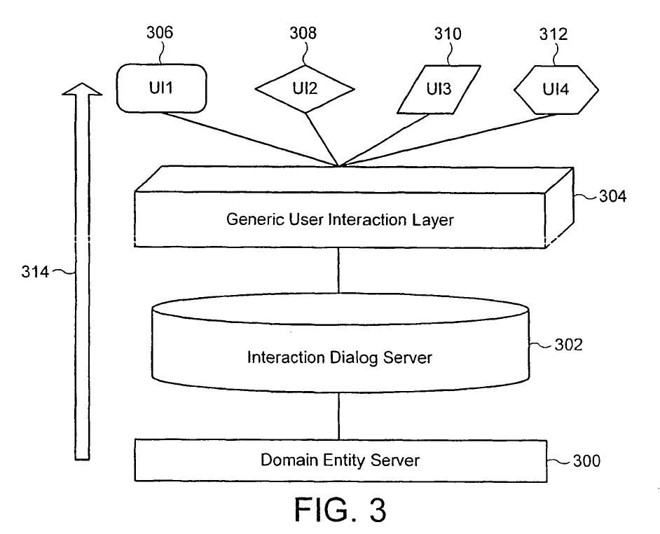

Referring to FIG. 3, there is illustrated the general principle of the present invention. Service management parameters (attributes) are provided by the domain entity server 300. The service management parameters are provided to the interaction dialog server 302 that uses the service management parameters to derive the management functionality to manage a service. The service management functionality, in terms of an interaction dialog, is then provided to a generic user interaction layer 304. Based on the interaction dialog and user-interface type specific rules and constraint, the generic user interaction layer 304 creates a relevant user interaction sequence for service management functionality for a specific user-interface type. The relevant user interaction sequence is then presented to the appropriate user-interface. In the example of FIG. 3 the generic user interaction layer 304 is connected to four user interfaces UI1 to UI4 labelled with reference numerals 306 to 312. Arrow 314 represents the flow of information in the operation.

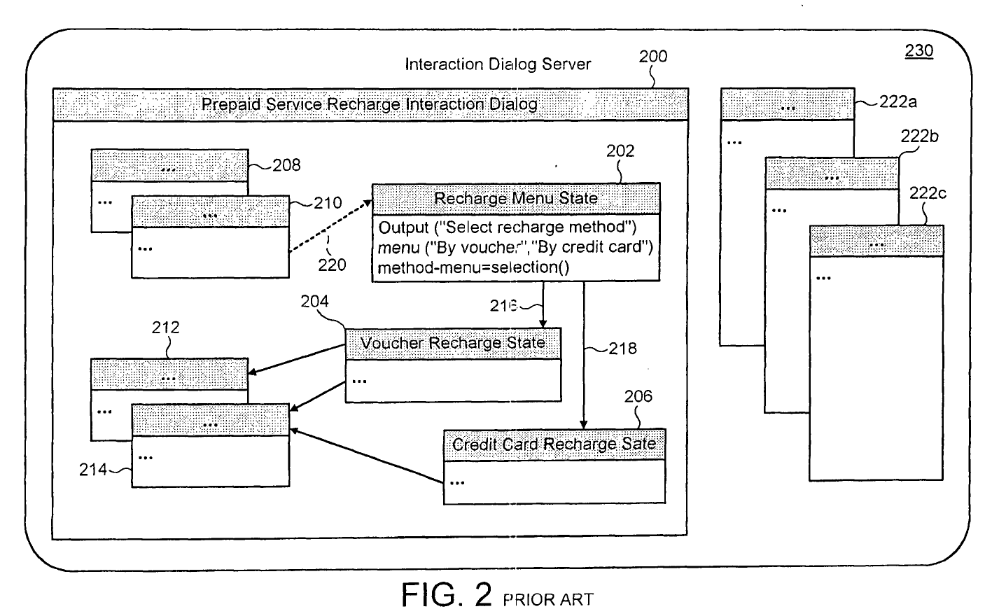

The present invention explicitly represents the interaction dialog under the constraints imposed by the domain, illustrated in FIG. 2 for the IN pre-paid service example. Explicit representations of the generic set of additional constraints imposed by each user-interface modality allows manual or automatic instantiation of interaction dialogs for all user-interface modalities. As a consequence, the user experiences the same sequence of information exchanges and transitions between conversational states (to the degree allowed by user-interface modality specific constraints), whether the user-interface modality is WEB, WAP (combining WML output and WML form input), IVR, SMS (combining SMS output and SMS input), Voice (combining verbal output and verbal input), Email (combining email output and email input) or others. Further, adaptation of existing interaction dialogs to future user-interface modalities is simplified to encompass solely the explicit representation of the generic constraints specific to the new user-interface modality.

Thus, in accordance with a preferred embodiment of the invention, there is provided a three step process.

In a first step, the management behavior of the service to be managed is expressed explicitly.

In a second step, a generic set of domain constraints and rules are applied.

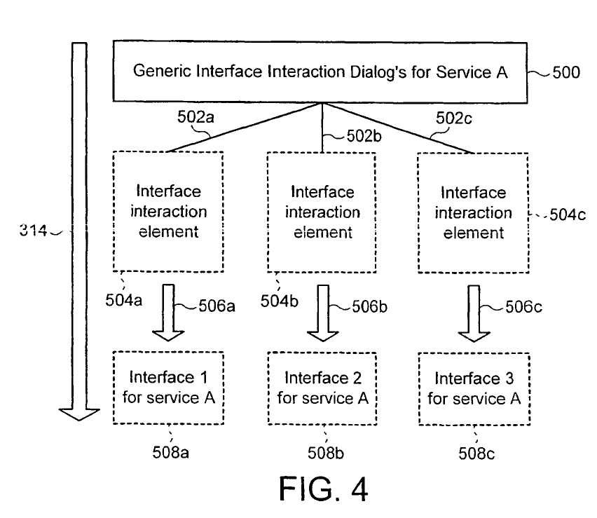

In a third step, as described further hereinbelow with reference to FIG. 4, user-interface modality specific interaction rules and constraints are applied.

Referring to FIG. 4, there is illustrated the main functional blocks of the generic user interaction layer 304 of FIG. 3 in an exemplary embodiment. The arrow 314, as in FIG. 3, illustrates the direction of data flow in the implementation of the invention.

The system is, in most practical situations, capable of supporting a plurality of different management services, and the example of FIG. 4 refers only to a description of one example management service, “service A”. A set of generic interface interaction dialogs for service A are provided, as illustrated by block 500. In practice such interaction dialogs are provided by the interaction dialog server 302.

An interface interaction element 504 is provided for each possible user-interface. In the example of FIG. 4 it is assumed that three user-interfaces are available, and thus three such elements 504a to 504c are provided. Each of the elements 504a to 504c receives data on a respective line 502a to 502c from block 500.

The interface interaction elements 504a to 504c use the associated interface interaction elements rules and constraints to build a specific interface from the generic interaction dialog provided by block 500. The specific interface built is, of course, specific to a particular user-interface.

An interface for each of the three available user-interface types is represented by blocks 508a to 508c. Each interface 508a to 508c receives data from the respective ones of the blocks 504a to 504c, as represented by arrows 506a to 506c. Each of the interfaces 508a to 508c is built with the specific rules and constraints expressed in the respective interface interaction elements 504a to 504c.

It should be noted that the interfaces 508 of FIG. 4 are the same as the user interfaces 306 of FIG. 3.

In accordance with the present invention the service parameters are provided to the interaction dialog server 302 in a generic format which is not dependent upon the user-interface modality of any of the user-interfaces 306 to 312. Preferably this generic format is extensible mark-up language (XML).

The domain entity server 300 is thus preferably adapted in accordance with this embodiment of the invention to intelligently create a management interface description, expressed in XML, to the interaction dialog server 302. XML is also advantageously used to define the user interaction suitable for each task necessary to manage that service, i.e. for each interaction dialog.

In accordance with the invention, the interaction dialog (i.e. the conversational finite state machine) is represented independently of the user-interface modality. The representation is used to construct modality specific instances of the interaction dialog when required by the user-interface modality chosen by a user at any given time.

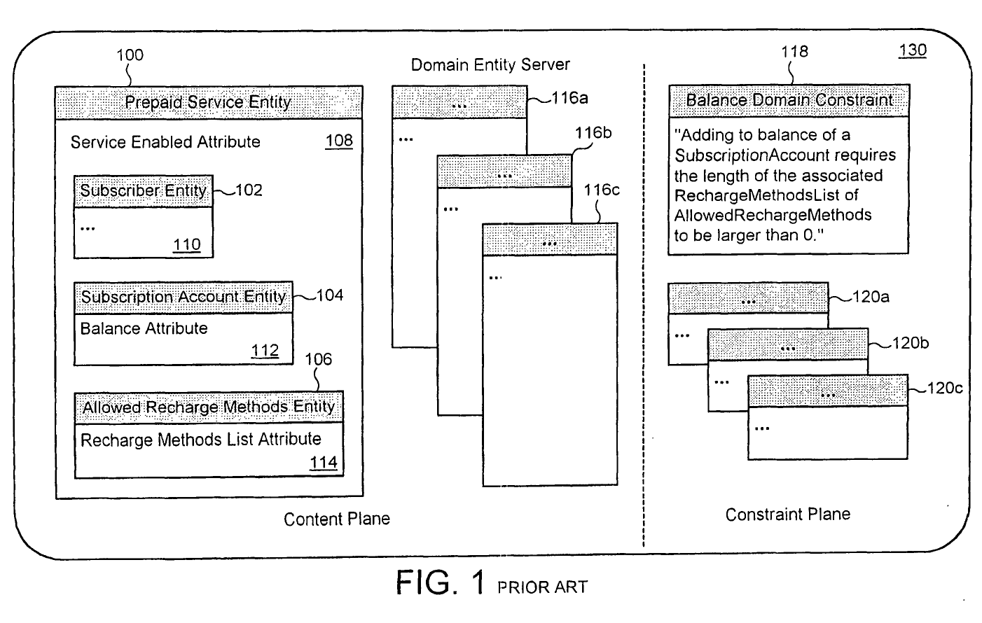

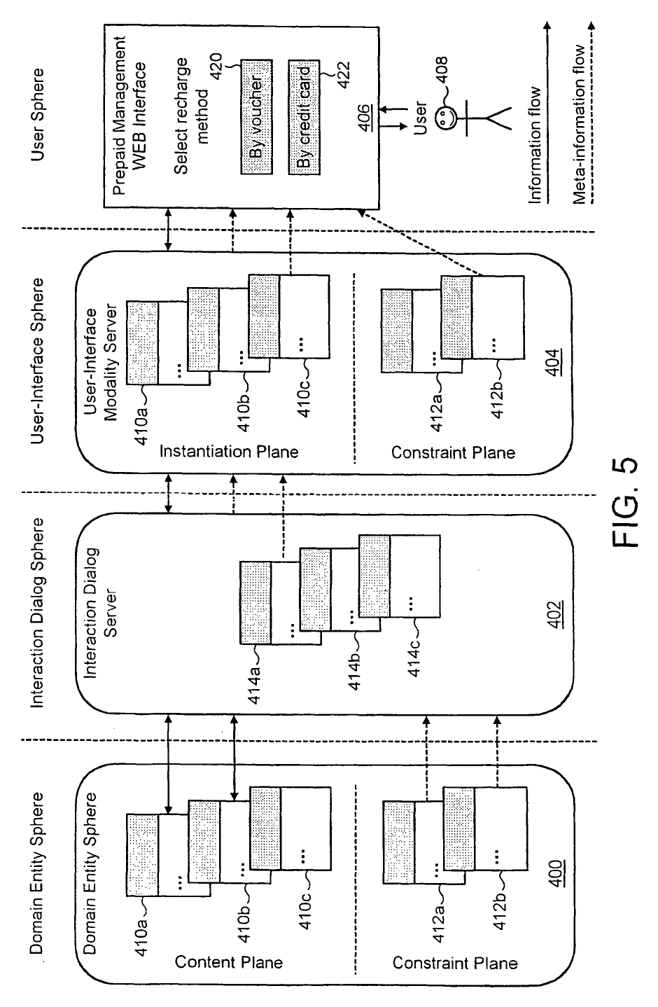

FIG. 5 illustrates in block diagram form the application of the invention to automatically instantiate, for a WEB user-interface modality, the recharge interaction dialog for the IN pre-paid service example used hereinabove with reference to FIGS. 1 and 2.

Domain entity and constraints information is accessed via the domain entity server 400. The domain entity server 400, provided in the domain entity sphere, includes a set of service entities 410a to 410c in its content plane, and a set of domain constraints 412a and 412b in its constraint plane. Information from the service entities and the constraints in the domain entity server are provided to an interaction dialog server 402. The interaction dialog server 402 includes dialogs 414a to 414c.

The explicitly represented generic interaction dialog is provided by the interaction dialog server 402 subject to the domain constraints of the domain entity server. The interaction dialog server 402 also provides explicit representations of the generic set of additional constraints imposed by each user-interface modality, indicated by numerals 418a and 418b.

While observing the appropriate user-interface modality constraints, a user interaction layer 404 instantiates the interaction dialog for the selected user-interface modality, and presents it to the user for interaction.

The blocks 416 represent interface interaction elements, containing user-interface specific instantiation rules for user-interface elements. For example, 416a may define how to express the representation of a set of selectable items for the WEB user-interface type, while 416b may express the corresponding representation for the IVR user-interface type.

The user interaction is provided via a user device 406, through which information is input from and output to a user 408. In this example the user device 406 has a WEB interface. The WEB interface is provided with interface means for enabling the user to select payment by credit card 420 or by voucher 422.

Although in FIG. 5 it is shown that the various servers are provided as separate entities, the invention is not limited to such an arrangement. The invention may be used in an equally advantageous manner in environments where functionality is provided on a single server, or where functionality is split between more than one server in a manner different to that shown in FIG. 5.

The present invention particularly advantageously provides the following benefits, amongst others:

a) Thin clients, with corresponding improvements in user-interface responsiveness;

b) Consistency (the user experiences the interaction in the same way, regardless of the chosen user-interface modality);

c) Adaptability for new user-interface modalities; and

d) Simple and user-interface modality consistent customability.

1. A user interaction layer providing an interface between a plurality of user-interfaces and a service management function, wherein the user interaction layer is a generic layer being user-interface modality independent and the service management function is associated with managing an account of at least one of a plurality of users.

2. A user interaction layer according to claim 1 wherein the account is a pre-paid account.

3. A user interaction layer according to claim 1 or 2 wherein the user interaction layer receives a generic definition of a management service from the service management function.

4. A user interaction layer according to claim 3 in which there is provided a plurality of means, respectively associated with the plurality of user-interfaces, for defining specific user-interfaces from the generic definition.

5. A user interaction layer according to claim 4 wherein the means are adapted to apply rules and constraints associated with the specific user-interface.

6. A user interaction layer according to any one of claims 1 to 5, wherein the service management function is provided to manage domain specific entities.

7. A user interaction layer according to any one of claims 3 to 6 wherein the generic definition is based on a generic interaction dialog.

8. A user interaction layer according to claim 7 wherein the interaction dialogs are configured to provide the user-interface modality independent user interaction layer.

9. A user interaction layer according to claim 7 or claim 8 wherein the interaction dialogs are provided by the service management function in extensible mark-up language.

10. A user interaction layer according to any one of claims 1 to 9 wherein the service management function represents an intelligent network block.

11. A interaction layer according to any one of claims 1 to 10 wherein a user-interface may be one of a WEB interface, a WAP interface, an SMS interface, an IVR interface, a voice interface, or an e-mail interface.

12. A method of providing an interface between a plurality of user-interfaces and a service management function comprising providing a generic interface layer being user-interface modality independent, wherein and the service management function is associated with managing an account of at least one of a plurality of users.

13. A method according to claim 12 wherein the account is a pre-paid account.

14. A method according to claim 12 or 13 further comprising providing the interface layer with a generic definition of a management service.

15. A method according to claim 14 wherein the generic definition of the service is provided by the service management function.

16. A method according to claim 14 or 15, further comprising defining, in the interface layer, a plurality of specific user-interfaces from the generic definition, each corresponding to one of the plurality of user-interfaces.

17. A method according to claim 16, wherein the specific user-interfaces are defined in dependence on rules and constraints associated with the specific user-interface.

18. A method according to any one of claims 14 to 17, wherein the generic definition comprises a generic interaction dialog.

19. A method according to claim 18, wherein the generic interaction dialog is defined in extensible mark-up language.

20. A method according to any one of claims 13 to 19 in an intelligent network element.

21. A system providing at least one service, wherein the service can be accessed by a user using one of a plurality of user-interfaces, wherein a service management function provides a generic definition of the management service and is associated with managing an account of at least one of a plurality of users, and a user-interface modality independent user interaction layer provides an interaction layer between the service management function and the one user-interface used by the user.

22. A system according to claim 21, wherein the account is a pre-paid account.

23. A system according to claim 21 or 22, wherein the interaction layer comprises means for deriving a plurality of definitions of specific user-interfaces from the generic definition of the management service, each corresponding to one of the plurality of user-interfaces.

24. A system according to any one of claims 21 to 23, wherein the service management function and the interaction layer are provided by a central service provider.

25. A system according to any one of claims 21 to 24, wherein each user-interface is provided on a user device.

26. An interaction dialog for defining the interaction of a user-interface, the interaction dialog being provided by a service management function for controlling a user interaction layer, wherein the user interaction layer provides an interface between a plurality of user-interfaces and the service management function, the interaction dialog being provided in a form independent of the user-interface modality, and the service management is associated with managing an account of at least one of a plurality of users.

27. An interaction dialog according to claim 26, wherein the account is a pre-paid account.

28. An interaction dialog according to claim 23 or 24 wherein the user interaction dialog provides a generic definition of a management service.

29. An interaction dialog according to claim 28 in which there is provided a plurality of means, respectively associated with the plurality of user-interfaces, for defining specific user-interfaces based on the interaction dialog.

30. An interaction dialog according to claim 29 wherein the means are adapted to apply rules and constraints associated with the specific user-interface.

31. An interaction dialog according to any one of claims 26 to 30 wherein the interaction dialog represents management service logic behaviour.

32. An interaction dialog according to any one of claims 26 to 31 wherein the interaction dialog is provided in extensible mark-up language.

33. An interaction dialog according to any one of claims 26 to 32 wherein the service management function is an intelligent network element.

34. An interaction dialog according to any one of claims 26 to 33 wherein the service management function controls the user interaction layer in extensible mark-up language.

35. An interaction dialog according to any one of claims 26 to 34, wherein the interaction dialog represents system constraints associated with a user-interface.

36. An interaction dialog according to claim 35, wherein a service is enables in accordance with rules associated with a service defined by said system constraints.

37. An interaction dialog according to any one of claims 26 to 36 wherein a user-interface may be one of a WEB interface, a WAP interface, an SMS interface an IVR interface, a voice interface, or an e-mail interface.

38. A method of defining the interaction of a user-interface comprising providing an interaction dialog from a service management function for controlling a user interaction layer, the user interaction layer providing an interface between a plurality of user-Interfaces and a service management function, the interaction dialog being provided in a form independent of the user-interface modality, and the service management is associated with managing an account of at least one of a plurality of users.

39. A method according to claim 38, wherein the account is a pre-paid account.

40. A method according to claim 39 wherein the user interaction dialog provides a generic definition of a management service.

41. A method according to any one of claims 38 to 40 in which there is defined a plurality of means, respectively associated with the plurality of user-interfaces, for defining specific user-interfaces based on the interaction dialog.

42. A method according to claim 41 Wherein the means apply rules and constraints associated with a specific user-interface.

43. A method according to any one of claims 38 to 42 wherein the interaction dialog is defined in extensible mark-up language.
